(19) United States
(12) Patent Application Publication
(10) Pub. No.: US 2010/0176317 A1
(43) Pub. Date: Jul. 15, 2010

(54) Radiation absorber with selective layers and additives

(76) Inventor: Peter C. Smith, Half Moon Bay, CA (US)

Correspondence Address: Peter C. Smith, 2411 S Cabrillo Hwy, Half Moon Bay, CA, 94019, US

(21) Appl. No.: 12/319,874

(22) Filed: Jan. 13, 2009

(51) Int. Cl. G21F 1/10; G21F 3/00

(52) U.S. Cl. 250/518.1; 250/515.1; 250/519.1

(57) ABSTRACT

The invention is a composite radiation absorber constructed from multiple layers of a rubber or rubber like matrix material filled containing a radiation absorptive element, or a plurality of radiation absorptive elements, that differ from layer to layer. The invention also teaches that mixtures of radiation absorbing elements within layers may improve overall radiation absorption performance. This multiple absorption approach offers significant advantages to users in the shielding of undesirable ionizing or acoustic radiation fields.

This invention differs significantly from prior art in that heterogeneous mixtures of differing absorbers and multiple (more than two) layers of material are used and found to be advantageous in the control of penetrating radiation fields.

This invention also differs from prior art in that some mixed or layered absorptive components also contribute significantly to the absorber utility as in the case of surface magnetic additives.

### SUMMARY

This invention involves a radiation absorber that is constructed from multiple layers. The layers each have specific purposes in controlling radiation intensity and or in making the absorber more effective to install and use. Layer additives may be mixed together.

### BACKGROUND

It is often advantageous to reduce and control the intensity of radiation fields in those cases where the uncontrolled radiation may be harmful to animals or interfere with the operation of equipment. In other cases it is important to absorb unwanted radiation that would otherwise interfere with the intended operation of measurement equipment. This invention defines the construction of multi component radiation shields that more effectively and efficiently control fields of radiation that may otherwise create unwanted radiation exposures. In the case of this invention, radiation will be assumed to be either ionizing radiation or acoustic radiation.

### DESCRIPTION OF MANNER AND PROCESS OF MAKING AND USING THE INVENTION

An absorber is constructed from two or more layers of polymer that itself exhibits absorptive, scattering or attenuating properties or from layers of a polymer that carries an absorptive element or a plurality of elements as a filler or fillers useful in controlling the radiation being targeted to control. This invention also describes absorbers that are constructed in two or more layers with each layer having a differing functional use in the performance of the radiation attenuation task. Typically each functional or absorptive layer is constructed of a rubber like material as a natural or synthetic rubber, latex, natural or synthetic polymer, elastomer, thermoplastic, or otherwise flexible member combined with an absorptive element or plurality of elements. This layer is then formed into the desired useful shape required by the application using conventional filled polymer forming processes. These processes include but are not be limited to, rolling, extruding, spraying, casting, or otherwise molding the layer into a shape useful in the application. The polymer set into its final shape using conventional polymer setting processes of cooling for thermoplastics, heating for thermosetting materials, polymerization by the admixing of polymerization accelerators, or by external reaction by polymerization accelerators, or other such techniques. Shapes may be regular as tapes, sheets, or cylinders, or be of specialty shapes as required by the shielding application. In each case this layer is combined with at least one other layer having a differing composition, radiation shielding, or installation fastening function. This second layer is also added using conventional forming processes of adhering, molding, rolling, spraying, calendaring, casting or similar processes. In all cases the finished article is functional and can be handled as a single component. In some cases one layer may utilize a similar matrix and absorptive filler as the next, differing only by the inclusion of an additional element. Layers need not be planar, but rather may be granular where the radiation absorption relies on the local availability of one layer to the next.

The invention is used by placing the absorber in between the radiation source and the item to be shielded or protected. It may be also installed as part of the item to be shielded, or used a either a permanent or temporary cover or shield for the item.

### FIGURES AND DRAWINGS DESCRIBING THE INVENTION

FIG. 1 shows a simple two layer radiation absorber, where layer A is an adhesive imparting the property of convenience to be held in place, and layer B is a polymer containing one or more radiation attenuating metals, heavy metals, carbon, hydrogen rich materials, lanthanides, or compounds of these materials.

FIG. 2 shows a two layer radiation absorber, where the layer A is a polymer that contains magnetic materials sufficient to allow the entire structure to self adhere to other ferrous or otherwise magnetic materials like are found in pipes, tanks, and other vessels attempting to be shielded. Layer A may be a homogeneous mixture or have discrete magnetic elements. This is a layer that provides the property of convenience to the user in the application and use of the absorber. Layer A mayor may not contain additional radiation absorptive fillers. Layer B is a polymer filled with and absorptive element or a plurality of elements, appropriate to control the incident radiation.

FIG. 3 is a three layer radiation absorber designed for high energy neutron radiation absorption. Layer A is a polymer layer designed to moderate the energy of high energy neutrons that is rich in hydrogen or other neutron moderating materials. Layer B is a polymer filled with neutron absorptive compounds such as gadolinium compounds, boron compounds or other materials with similar high neutron absorption cross section properties. Layer C is a polymer layer filled with one or more radiation attenuating metals, heavy metals, or compounds thereof to control lower energy radiation.

FIG. 4 is a two layer radiation absorber, where layer A is a polymer containing one or more radiation attenuating metals, heavy metals or compounds thereof, and layer B is an outside layer containing an absorptive filler with the characteristic of X ray line absorption edge absorption useful and efficient in trapping the characteristic or fluorescent radiation generated by the absorptive filler used in Layer A. In the case of lead or tungsten as the metallic member in layer A, then metals or alloys, elements or compounds containing iron, chromium, or nickel would be effective in efficiently absorbing the heavy metal's fluorescent radiation emissions. In some cases a homogeneous mixture of these layers will provide acceptable results as in the case where the iron alloys are mixed in the proper proportions with the heavy metal elements.

FIG. 5 is a radiation absorber described in FIGS. 1 through 4 that has an additional enhancement. This figure depicts an absorber enhanced with a colored layer to allow identification in use as an advantage to the user.

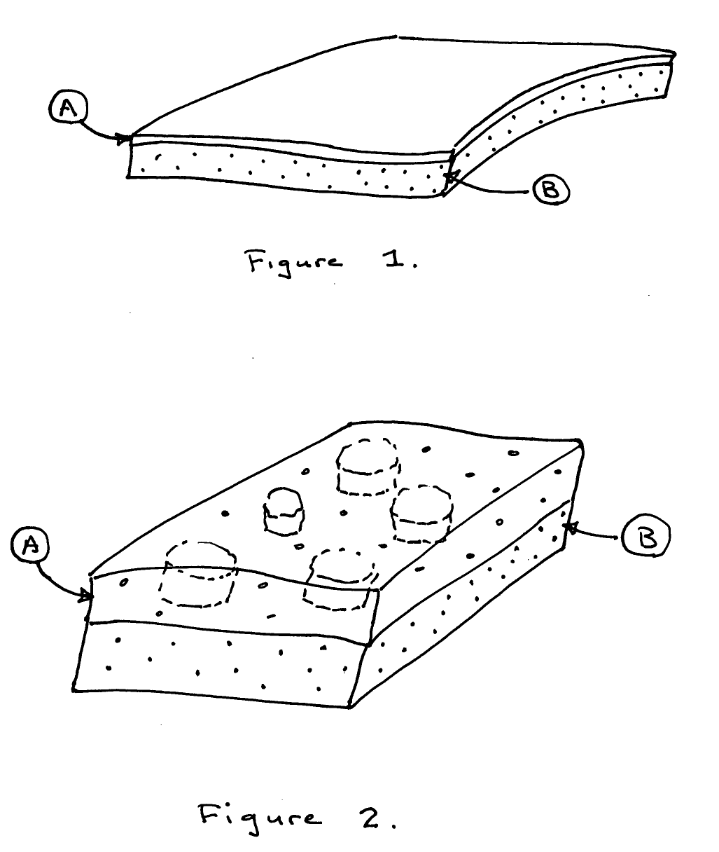

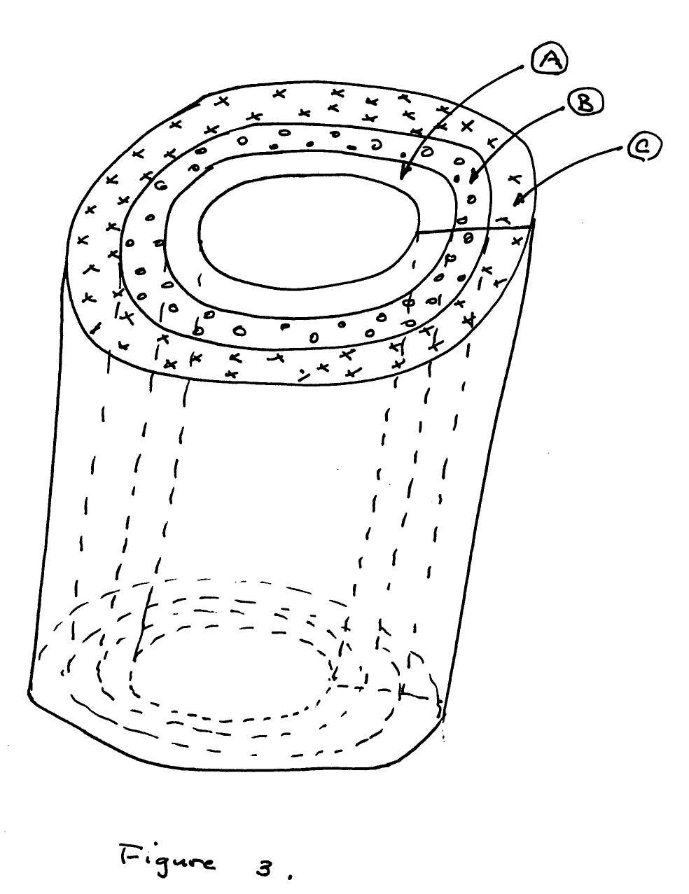

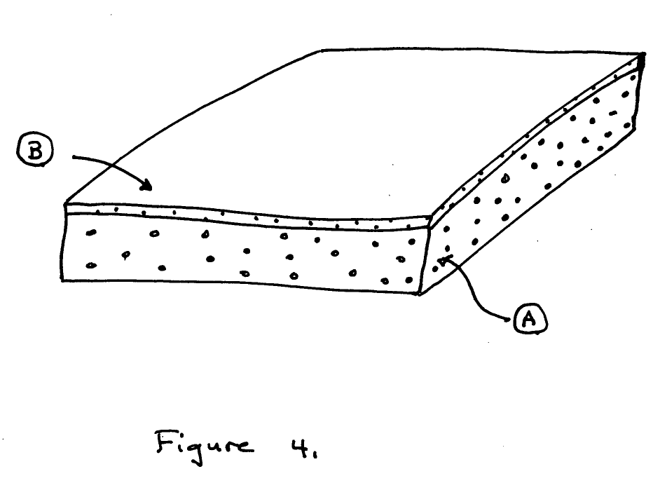

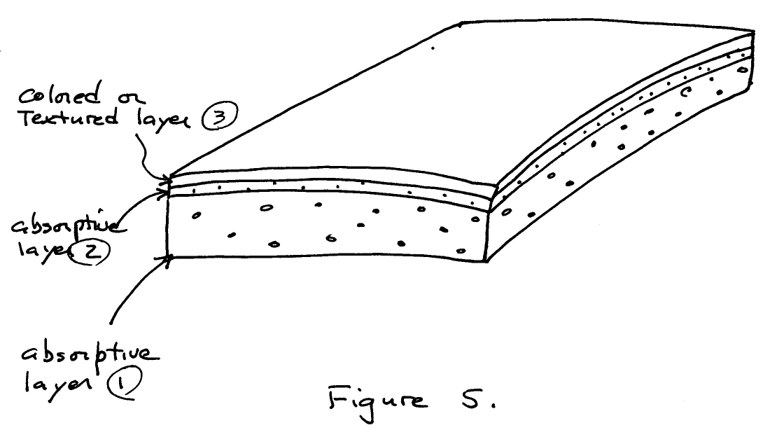

The concepts described in these figures can also be mixed or combined to create specialty multi layer or multi-zoned absorbers tailored to a particular use application. In the specific case of the absorption of acoustic radiation, controlled zones of differing acoustic properties can be designed into the multilayer absorber to suit the intended purpose.

What is claimed is:

1. A radiation absorber that containing multiple selective functional layers and or zones.

2. Claim 1 where the radiation absorber is constructed using a flexible polymer matrix.

3. Claim 1 where one layer contains materials that promote magnetic adherence to ferromagnetic materials like steels.

4. Claim 1 where one layer is an adhesive suitable to hold the entire absorber in place.

5. Claim 1 where one layer performs the purpose of identification or decoration that is by color or texture.

6. Claim 1 where one layer absorbs high energy radiation, and a second or a plurality of layers absorb sequentially lower energy radiation.

7. Claim 1 where the inner layer is largely a neutron moderator, a subsequent layer is a neutron capture layer, and a third layer captures gamma and X ray energy radiation.

8. Claim 1 where the outer layer contains absorbers efficient in capturing characteristic fluorescent radiation generated in the next inner layer or adjacent zone.

9. Claim 6 where the neutron moderator is itself a layered material.

10. Claim 1 where each or any absorptive layer may contain a plurality of absorptive elements designed for the radiation being controlled.

11. Claim 1 where the radiation being absorbed is acoustic radiation.
